(19) United States
(12) Patent Application Publication
(10) Pub. No.: US 2007/0220841 A1
(43) Pub. Date: Sep. 27, 2007

(54) Pony bar

(76) Inventor: Jennifer Suzanne Van Deren, Gilroy, CA (US)

Correspondence Address: Jen Van Deren, 1120 Fitzgerald Ave., Gilroy, CA, 95020, US

(21) Appl. No.: 11/384,934

(22) Filed: Mar. 21, 2006

(51) Int. Cl. B68C 1/02

(52) U.S. Cl. 54/44.1

(57) ABSTRACT

The Pony Bar is a handle bar that attaches to the horn of a western horse saddle. The purpose of the handle bar is to provide a safety mechanism for kids to hold on to while sitting in the saddle and riding. The components of the handle bar are comprised of various materials including metal pipe, connecting bolt(s), bolt fasteners and hand grip material. The bar helps a rider stabilize his/herself and therefore helps to prevent falls and encourage confidence and balance while in the saddle.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC or REFERENCE TO A “MICROFICHE APPENDIX”

Not Applicable

### BACKGROUND OF THE INVENTION

1. The Problem

Kids learning to ride do not have a part of the saddle to easily hold on to. The western saddle horn is vertical and not well-shaped for supporting the rider should the horse move suddenly or unexpectedly such as when a horse spooks, trips, shakes, turns or trots.

2. The Idea

Design a device for kids to easily hold on to so they are less likely to fall off. English saddles have no place to hold on and western saddles have a horn, but it is not easy for kids to grip. The Pony Bar allows riders a stable, ergonomic handle to help prevent falls and encourage confidence and balance while training, pleasure riding and therapeutic riding.

### BRIEF SUMMARY OF THE INVENTION

The Pony Bar is a handle bar that attaches to the horn of a western horse saddle. The purpose of the handle bar is to provide a safety mechanism for kids to hold on to while sitting in the saddle and riding. The components of the handle bar are comprised of various materials including metal pipe, connecting bolt(s), bolt fasteners and hand grip material. The bar helps a rider stabilize his/herself and therefore helps to prevent falls and encourage confidence and balance while in the saddle.

### BRIEF DESCRIPTION OF THE SEVERAL VIEWS OF THE DRAWING(S)

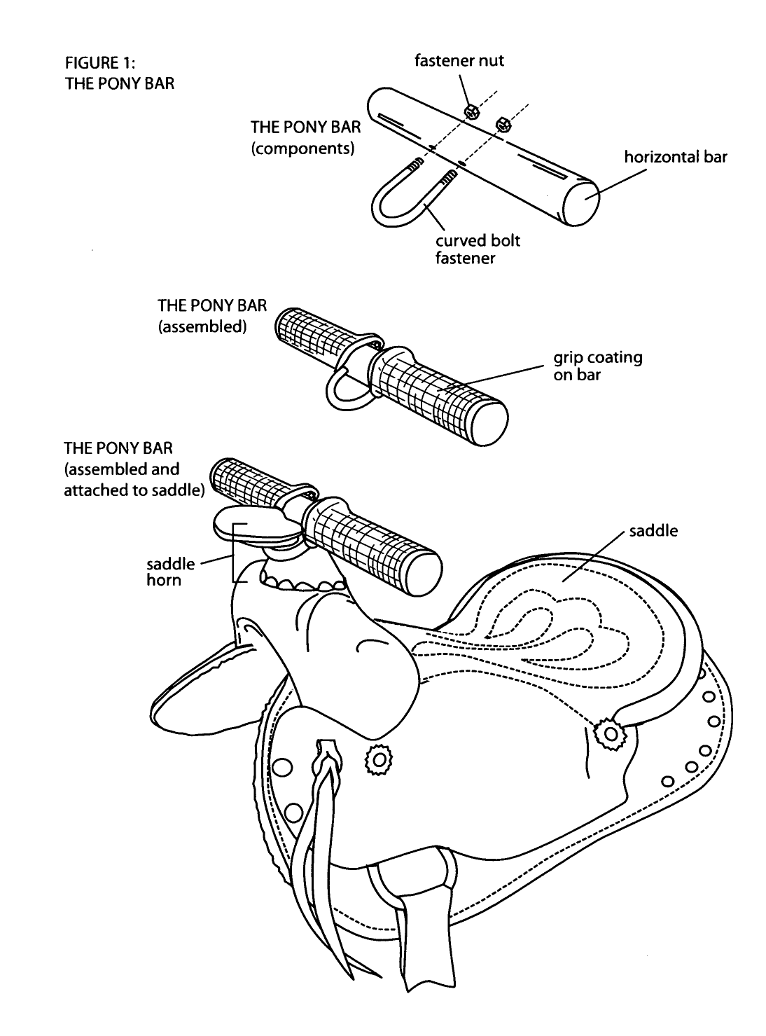

Included in this application is a drawing entitled FIG. 1: The Pony Bar. The drawing (FIG. 1: The Pony Bar) is an exploded view showing (a) The Pony Bar components, (b) The Pony Bar assembled, and (c) The Pony Bar assembled and attached to saddle.

### DETAILED DESCRIPTION OF THE INVENTION

The Pony Bar is a handle bar that securely attaches to the horn of a western horse saddle and can withstand the rigors of everyday riding. It can be used as a permanent addition to any western saddle or it can be used as a removable device that when removed does not harm the integrity of the saddle structure nor cause any blemishes to the exterior of the saddle.

1. A handle bar that attaches to a horse saddle and is comprised of a horizontal bar attached to the saddle horn via a threaded bolt and bolt fasteners that allow the horizontal bar to be tightened securely into position.

2. A handle bar in accordance with claim 1 that is removable.

3. A handle bar in accordance with claim 2 that is made of any stiff material including metal, wood or plastic and may or may not be grip coated with a protective material such as rubber, fabric or plastic.
